(19) United States
(12) Patent Application Publication
(10) Pub. No.: US 2006/0085852 A1
(43) Pub. Date: Apr. 20, 2006

(54) Enterprise assessment management

(76) Inventor: Caleb Sima, Woodstock, GA (US)

Correspondence Address: LAVA Group Law by Smith & Frohwein, P.O. Box 88148, Atlanta, GA, 30356, US

(21) Appl. No.: 10/969,267

(22) Filed: Oct. 20, 2004

(51) Int. Cl. G06F 12/14

(52) U.S. Cl. 726/22

(57) ABSTRACT

Systems, methods, and computer programs for managing vulnerability assessment of a computer network are provided. One embodiment is an enterprise assessment management system, which comprises: a plurality of scanning tools including at least one web application scanning tool; and an enterprise assessment management server comprising a scanner manager that controls the plurality of scanning tools.

### BACKGROUND

As the number, complexity and importance of computing networks has increased, many corporations, schools, organizations, and other enterprises and individuals have placed increasing importance on the security of the computing networks. In an effort to promote the security of their underlying computing networks (often referred to as an enterprise network, or merely an enterprise), information technology professionals have developed and implemented various tools for assessing the security vulnerabilities of computing networks.

One of the most common approaches is to employ security assessment devices, which are used to evaluate various elements in the network (e.g., desktop computers, servers, routers, etc.) and assess their respective vulnerability to attack from hackers. In general, these devices scan the particular target element on the network and provide an assessment of the vulnerability of that element. For example, a number of so-called scanning tools exist for assessing the vulnerability of various aspects of computing networks. Currently, there are a number of companies that offer stand-alone scanning tools (e.g., system scanners, database scanners, and network scanners). In order to assess the vulnerability of the entire network, an enterprise may be forced to use a number of different scanning tools, many of which are typically developed, licensed, and maintained by different vendors. Each of the scanning tools typically includes a component that enables an administrator to control the vulnerability assessment process for the corresponding network element.

Nonetheless, due to the increasing importance of the security of computer networks, there is a need in the art for improved systems, methods, and computer programs for managing the vulnerability assessment process.

### SUMMARY

Systems, methods, and computer programs for managing vulnerability assessment of a computer network are provided. One embodiment is an enterprise assessment management system, which comprises: a plurality of scanning tools including at least one web application scanning tool; and an enterprise assessment management server comprising a scanner manager that controls the plurality of scanning tools.

Another embodiment is an enterprise assessment management platform comprising: a scanner manager configured to control a plurality of scanning tools, at least one of the plurality of scanning tools comprising a web application scanning tool; a repository for storing scanning data corresponding to the plurality of scanning tools; and a user interface that controls communication with at least one user console.

A further embodiment is a method for assessing the vulnerability of an enterprise network. One such method comprises: configuring a plurality of scanning tools for communication with a scanner manager, at least one of the plurality of scanning tools comprising a web application scanning tool; connecting at least one of the plurality of scanning tools to the scanner manager; requesting scheduling data from a repository; and automatically scheduling a scan task to implemented on the corresponding scanning tool based on the scheduling data retrieved from the repository.

### BRIEF DESCRIPTION OF THE DRAWINGS

Many aspects of the invention can be better understood with reference to the following drawings. The components in the drawings are not necessarily to scale, emphasis instead being placed upon clearly illustrating principles in accordance with exemplary embodiments of the present invention.

FIG. 1 is a block diagram of an embodiment of an enterprise assessment management system.

FIG. 2 is a is a block diagram of an embodiment of the scanner manager and the repository of FIG. 1.

FIG. 3 is a flow chart illustrating the architecture, operation, and/or functionality of an embodiment of the user interface of FIG. 2.

FIG. 4 is a screen shot of an embodiment of a window of a graphical user interface supported by the user interface of FIGS. 2 and 3.

FIG. 5 is a flow chart illustrating the architecture, operation, and/or functionality of another embodiment of the user interface of FIG. 2.

FIG. 6 is a flow chart illustrating the architecture, operation, and/or functionality of an embodiment of the scan data translation module of the repository of FIG. 2.

FIG. 7 is flow chart illustrating the architecture, operation, and/or functionality of another embodiment of the scan data translation module of the repository of FIG. 2.

FIG. 8 is a flow chart illustrating the general architecture, operation, and/or functionality of the automated scan scheduler of FIG. 2.

FIG. 9 is a flow chart illustrating the general architecture, operation, and/or functionality of another embodiment of the automated scan scheduler of FIG. 2.

FIG. 10 is a block diagram illustrating an exemplary implementation of a scanning tool and scanner manager of FIG. 2.

### DETAILED DESCRIPTION

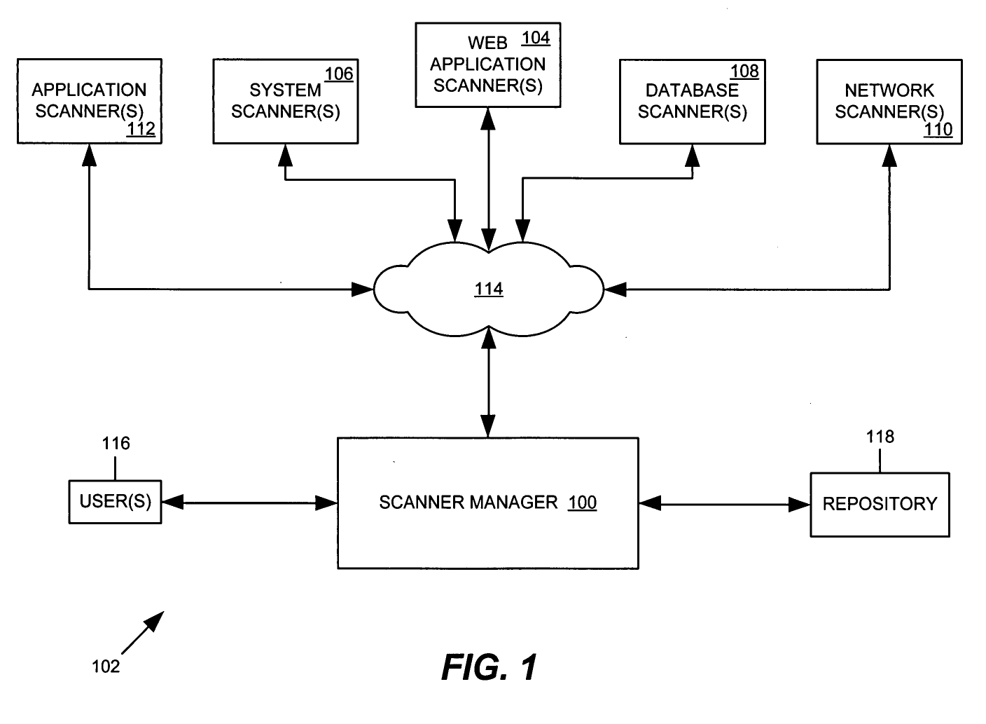

This disclosure relates to various embodiments of systems, methods, and computer programs for managing vulnerability assessment of a computer network (e.g., an enterprise network). Several embodiments will be described below with reference to FIGS. 1-10. As an introductory matter, however, the basic architecture, operation, and/or functionality of an exemplary embodiment of an enterprise assessment management platform will be described.

In general, the enterprise assessment management platform provides a scalable distributed framework for managing multiple vulnerability assessment sensors or scanners (i.e., scanning tools) across the entire enterprise network. The scanning tools (e.g., application scanner(s), system scanner(s), web application scanner(s), database scanner(s), network scanner(s), etc.) communicate with a scanner manager that functions as a central point of control. Therefore, the scanner manager may control the vulnerability assessment process for all of the scanning tools in the enterprise. It should be appreciated that the enterprise assessment management platform supports various types of enterprise scanning tools, including third-party scanning tools, future scanning tools, etc.

The scanner manager also provides a user interface for enabling users to access various services provided by the platform. In this regard, the enterprise assessment management platform provides the capability for robust scanning of various aspects of the enterprise. Furthermore, any number of scanning tools may be added to the platform as needed, and a robust scheduling system enables an organization to automate assessments of their organization's application security.

A number of the services supported by the enterprise assessment management platform are described below in detail. Nonetheless, a few exemplary services, functions, features, etc. will be briefly described. For instance, the scanner manager may be integrated with a data repository that stores scan results. The central repository enables the platform to generate various reports pertaining to the security of the enterprise as a whole and to perform a detailed trend analysis across multiple servers.

As noted above, the enterprise assessment management platform supports a robust scheduling system for performing assessments, such as, regularly scheduled assessments, ranges of time, and blackout periods when no scanning is to be performed. In this manner, the enterprise assessment management platform enables an organization to automate the vulnerability assessment process. Various users with differing responsibilities are also able to connect to the enterprise assessment management platform through consoles. The enterprise assessment management platform may also support the concept of user roles, which limit the functionality of the architecture based on which user is connected. Therefore, when a user logs into the system via a console, the enterprise assessment management platform may control which functions, features, etc. are provided to the user based on roles/permissions stored in the repository.

The enterprise assessment management platform also supports security policy enforcement. The enterprise assessment management platform provides a central repository of scan policies and enforces roles which dictate who can create and modify policies. This feature may ensure that the same scan policies are run across the entire enterprise.

The enterprise assessment management platform may also provide an alerting mechanism that notifies user(s) of various events, conditions, etc. associated with the vulnerability assessment process (e.g., scan completion, error conditions, etc.). It should be appreciated that the alerting mechanism may facilitate the process of automating the enterprise's vulnerability assessments because an administrator may be able to schedule regular scans and be notified when they complete or if there is a problem.

The scanner manager may be configured to allow for expansion of its capabilities by utilizing plug-ins in various components that have to deal with scanner-specific items, such as command and control and results interpretation. Therefore, the enterprise assessment management platform is flexible enough to support additional scanning tools, including third-party scanning tools.

Having described the general architecture, operation, and/or functionality of an exemplary embodiment of an enterprise assessment management platform, various additional embodiments will be described with reference to the drawings. FIG. 1 illustrates an embodiment of an enterprise assessment management system 102. As illustrated in FIG. 1, enterprise assessment management system 102 comprises a scanner manager 100, a repository 118, user(s) 116, and various scanning tool(s), such as web application scanner(s) 104, system scanner(s) 106, database scanner(s) 108, network scanner(s) 110, application scanner(s) 112, etc.

Scanning tools 104, 106, 108, 110 and 112 are located on a computer network 114, which may comprise any network—regardless of the transmission medium, topology, etc. Enterprise assessment management system 102 supports any number of scanning tools. Scanning tools 104, 106, 108, 110 and 112 are configured to perform a vulnerability assessment of one or more aspects of computer network 114. In other words, scanning tools 104, 106, 108, 110 and 112 provide the actual scanning or security auditing functionality.

Some scanning tools may be enterprise compliant (i.e., native to scanner manager 100), while others may be nonconforming (e.g., legacy scanners, third-party security auditing tools, etc.). As described in more detail below, nonconforming scanning tools may be wrapped by an adapter layer. Scanner manager 100, however, does not distinguish between enterprise-compliant scanning tools and scanning tools that are integrated with an adapter layer.

In the embodiment illustrated in FIG. 1, enterprise assessment management system 102 includes tools for scanning web applications, databases, and applications, as well as other aspects, elements, etc. of computer network 114. An application scanner generally refers to a device whose primary purpose is to assess software applications and to identify security vulnerabilities that may be contained within them. An application may reside on a server, a user's desktop, laptop, or some other area of a network. Furthermore, an application may be distributed across multiple locations, devices, etc. A system scanner generally refers to a device whose purpose is to assess a system for system-based vulnerabilities, and may include any device that is connected to a network, such as hardware devices, software devices, or a combination of both. A web application scanner generally refers to a device whose purpose is to scan web applications for security vulnerabilities. A web application may be external facing outside an organization, internal facing internal to the organization, or between an organization and specific other external organizations. A database scanner generally refers to a device whose purpose is to scan for security vulnerabilities contained within a database application. The vulnerabilities may be specific to a particular database application or generic in nature to all database applications. The database scanner may assess the database directly, without having to access the database through a separate application. A network scanner generally refers to a device whose purpose is to scan for security vulnerabilities across a network. The network may contain several types of devices, such as communications devices, firewalls, switches, hubs, etc. A network scanner scans the devices on the network to identify security vulnerabilities contained within the network. It should be appreciated that enterprise assessment management system 102 may employ other types of scanning tools. Furthermore, enterprise assessment management system 102 need not include all of the scanning tools illustrated in FIG. 1.

Scanner manager 100 is also located on computer network 114 (or capable of connecting to computer network 114 as needed). In general, scanner manager 100 controls all of the scanning tools installed into the scanning infrastructure. For example, scanner manager 100 schedules scans to be implemented on scanning tools 106, 108, 110 and 112 and monitors the progress of the scans. Scanner manager 100 also provides an interface to repository 118, which manages all persistent information in the architecture. Repository 118 provides an interface to other components of the architecture for storing and retrieving scan data, as well as other types of data used by scanner manager 100 (e.g., scheduling information, scan results, enterprise activity logs, role management data, policy information, etc.).

Scanner manager 100 also provides an interface to console(s) which enable user(s) 116 to access the services provided by scanner manager 100. For example, in one embodiment, the console(s) provide user(s) 116 with a graphical user interface for presenting the various features supported by scanner manager 100. Multiple consoles may be concurrently connected to scanner manager 100. As described below in more detail, in some embodiments, the functionality of a console may be dictated by the roles, permissions, etc. available to the specific user. Scanner manager 100 provides a flexible interface to the console(s), which may enable the functionality of the console(s) to be expanded through additional plug-in modules.

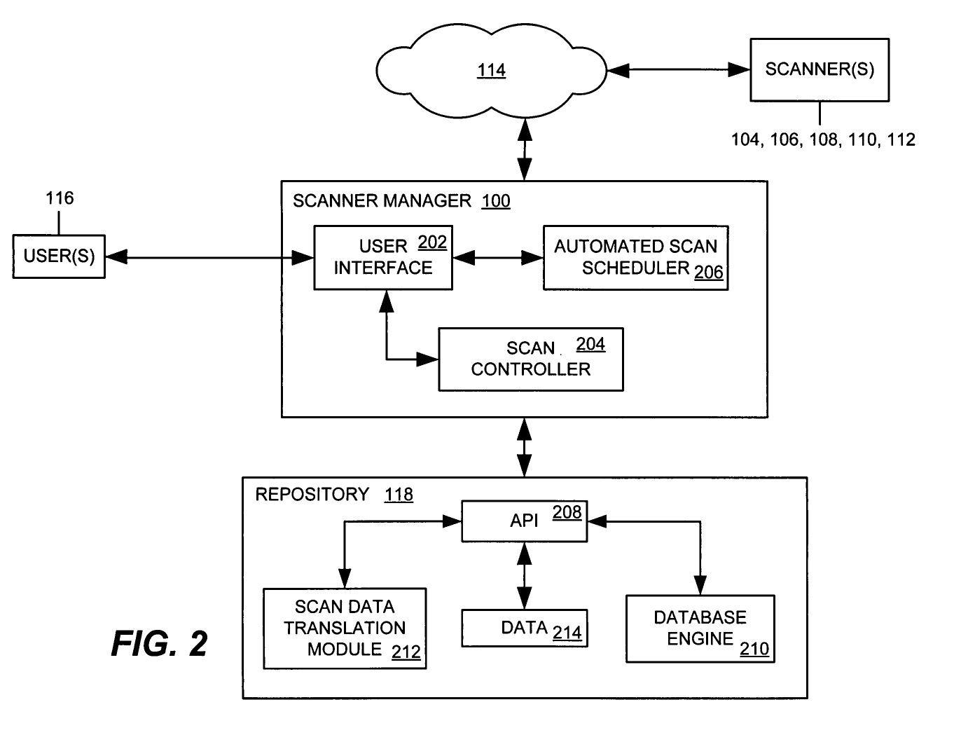

Referring to FIG. 2, it should be appreciated that the components in enterprise assessment management system 102 may be configured to interface in a number of ways. In one embodiment, the consoles and scanning tools communicate with scanner manager 100 and repository 118 via a remote API, such as standard .NET Remoting interfaces. In this manner, enterprise assessment management system 102 may be implemented in a distributed environment across multiple machines, which may enable user(s) 116 to remotely access the system. Network traffic for remote calls into scanner manager 100 and repository 118 may be encrypted using, for example, an SSL-based encryption scheme to protect sensitive data that could be “sniffed” from network 114. Depending on the particular system configuration, however, scanner manager 100 may also communicate over network 114 to database engine 210. Communication between scanner manager 100 and database engine 210 may use, for example, standard SQL Server protocols.

Referring to the embodiment in which .NET Remoting interfaces are employed, scanner manager 100 is the central controller for all operations in the platform. It is the single point of contact for both the consoles and the scanning tools. Scanner manager 100 supports multiple sensors, and can distribute different scanning tasks to each scanning tool. Scanner manager 100 may also support multiple consoles, so different users can be monitoring and configuring different areas of the system simultaneously. Scanner manager 100 may be configured to minimize any firewall-related requirements for enabling access to the platform. Scanner manager may be configured to listen on a single port for NET Remoting requests, and both the console(s) and scanning services make connections to scanner manager 100. In this manner, only scanner manager 100 requires incoming access through the firewall. The consoles and scanning services may employ outgoing access to connect to the remoting port for scanner manager 100. Scanner manager 100 may employ outgoing access to connect to repository 118.

In the .NET embodiment, repository 118 may provide centralized server storage for all data used by scanner manager 100, including a vulnerability database and policy data, scan results data, reporting information extracted from the vulnerability database, and object data for all configurable entities such as scan profiles, scheduled scans, and black-out contingencies. Repository 118 may only be accessed by scanner manager 100. The consoles and scanning tools may make remoting calls to scanner manager 100 to get access to the data in repository 118. In one exemplary implementation, repository 118 comprises three components: an SQL server database; repository storage; and repository import. The SQL server database provides physical data storage, and includes stored procedures for retrieving or updating the data. Repository storage provides .NET interfaces that encapsulate the details of how objects in the platform are stored and accessed in the physical storage. Repository import provides .NET interfaces that encapsulate the details of how information is extracted from scanner-specific data files and inserted into repository 118.

Data is manipulated and passed between components of the system using framework objects that provide an object-oriented view of the data. Repository storage classes encapsulate all of the details of how the data in the framework objects is mapped into the physical data storage format. They also encapsulate all of the details of the interface to the physical storage system. Physical data storage is in an SQL Server database. The repository storage classes interface to the stored procedures in the database to retrieve or update the data.

Data files for policies and scan results may be stored in repository 118 as raw data, allowing each scanning implementation to store the data in any format it chooses. However, sometimes additional information may be extracted from these raw data files and inserted into other tables in repository 118. For example, in order to run some reports for a scan, the scan results may be extracted and placed into the SQL Server tables that the report uses. The repository import interfaces define methods for importing scanner-specific policy and scan results data files into repository 118. For each scanning tool, an implementation of these interfaces may be provided that understands the data format inside the data files. Furthermore, a factory class may also be provided that contains methods to create instances of the appropriate implementation classes based on the scanning type. It should be appreciated that the factory class may be easily modified to create different implementation objects depending on the scanning type. For example, the platform may include a mechanism for specifying the import classes for each scanner type in a configuration file.

In alternative embodiment, scanner manager 100 employs framework objects (e.g., data containers) that provide two main functions: (1) provide means to store complex data internally within the services and the console, and transfer it via NET Remoting interfaces; and (2) provide convenience methods for use by the consoles to hide the details of the .NET Remoting interface into scanner manager 100. The framework objects may be used whenever information about an entity needs to be stored in memory or passed between components. The objects may be marked as serializable to allow them to be passed across .NET Remoting boundaries. Passing data objects may reduce the complexity of the remote method interfaces, and may allow additional properties to be added without changing the definition of the interface.

Furthermore, it should be appreciated that the framework objects may provide methods that allow them to be used like a typical object-oriented framework in a client application. These methods may be used by the consoles, and also define an API that is available for driving scanner manager 100 from a custom application. There are static methods that primarily allow retrieving either an instance of a specific object or a collection of objects. Each object also has instance methods for performing operations on that particular object such as updating the data in repository 118 or executing remote operations such as starting a scan. Objects that have relationships to other objects also provide properties that will retrieve and return a related object when it is needed.

With the exception of a few methods that perform calculations on the data values of the object, the methods on the framework objects may be wrappers around remote interface calls to the services provided by scanner manager 100. As such, these methods may not be used internally by scanner manager 100 and scanning services. The services may treat the objects as simple data containers rather than full-fledged objects that encapsulate both data and functionality, so operations on the objects may be performed by passing them as parameters to functions.

With regard to scanning tools 104, 106, 108, 110 and 112, scanner manager 100 may provide various functions for controlling scans. For example, in one embodiment, scanner manager 100 supports the following functions:
GetStatus—gets the current status of the sensor
StartScan—starts a new scan
AbortScan—aborts the running scan
SuspendScan—suspends the running scan so that it can be resumed at a later time
ResumeScan—resumes a previously suspended scan.
GetScanResults—gets the results of a completed, failed, or aborted scan.
GetJobStatus—gets the current status of a job on the scanning tool (running, suspended, complete, failed, etc.)
Pause—pauses the operation of the scanning tool (if a scan is currently running, it will be suspended and the scanning tool will not accept any requests to start or resume a scan while it is paused)
Continue—continues the operation of a paused scanning tool (if a scan was running when the sensor is paused, that scan is automatically resumed)

Scanner manager 100 also provides a remote interface that scanning tools may call to notify the framework of significant state changes. It should be appreciated that any of the following, or other, callbacks may be provided:
OnSensorStart—indicates that the scanning tool is online and available to perform scanning
OnSensorStop—indicates that the scanning tool is shutting down and will no longer be available for scanning
OnSensorPaused—indicates that a requested pause of the scanning tool has been completed, and that any scan that was running has now been suspended (the scanning tool may not accept any requests to start a resume of a scan until it is told to continue, or until the scanning service is restarted
OnSensorContinued—indicates that a requested continue of a paused scanning tool has been completed (if a scan was suspended when the scanning tool was paused, that scan has been resumed)
OnScanStarted—indicates that a requested scan has been started successfully
OnScanComplete—indicates that a scan has completed successfully
OnScanFailed—indicates that a scan has failed
OnScanAborted—iIndicates that a requested abort has been completed
OnScanSuspended—indicates that a running scan has been suspended
OnScanResumed—indicates that a suspended scan has been resumed successfully
   The same (or other) callback interface may also provide methods that a scanning tool may use to get the data it needs from repository 118. Any of the following, or other, types of methods may be employed:
GetPolicyData—returns a Stream object that can be used to read the data for a policy file (the scanning tool uses this method when it needs to synchronize local policy data with the master version stored in repository 118)
GetCustomAgentData—returns a Stream object that can be used to read the data for a custom agent file
GetCheckDatabaseData—returns a Stream object that can be used to read the data for a Vulnerability database file (the scanning tool uses this method when it needs to synchronize local Vulnerability database data with the master version stored in repository 118)

When initiating a scan, scanner manager 100 may employ, for example, a StartScan method in a Job object. The Job object may provide suitable information for scanning via the following properties:
StartUri property—defines the target that is to be scanned. Interpretation of the URI is entirely up to the scanning implementation. For example, a URI with an “http:” or “https:” protocol may be used for Web application scanning, while other scanning tools may define a different URI protocol to specify the information needed to identify the target.
Policy property—defines the policy to apply to the scan. The scanning tool may retrieve the raw data for the policy file using the GetPolicyData callback method described above.
Settings property—defines all scanner-specific settings that control options for the scan. The Settings property may be a generic string field whose content is interpreted by each scanning implementation.

Having described the general features, operation, etc. of the .NET embodiment, a more general implementation of scanner manager 100 and repository 118 will be described with respect to FIG. 2. One of ordinary skill in the art will appreciate, however, that other implementations may be employed. For instance, it should be appreciated that any of the components of scanner manager 100 may be relocated in repository 118 and, vice versa, any of the components of repository 118 may be located in scanner manager 100. Furthermore, the functionality of scanner manager 100 and repository 118 may be implemented as a single component. In further embodiments, the functionality of scanner manager 100 and repository 118 may be implemented as two or more distributed components.

Referring to the embodiment of FIG. 2, scanner manager 100 comprises a user interface 202, a scan controller 204, and an automated scan scheduler 206. Repository 118 comprises an application program interface 208, a database engine 210, a scan data translation module 212, and memory for storing various types of data 214 used by the system. The functionality, operation, and/or architecture of each of these components is described below in detail.

User interface 202 enables user(s) 116 to access the functionality provided by scanner manager 100, repository 118, etc. As illustrated in FIG. 2, user interface 202 may be linked to scan controller 204 and automated scan scheduler 206. Scan controller 204 provides the functionality, logic, etc. for controlling scan tasks being implemented via scanning tools 104, 106, 108, 110 and 112. For example, scan controller 204 may provide tools for starting, stopping, pausing, etc. active scan tasks. As described in more detail below, automated scan scheduler 206 provides a mechanism for automatically scheduling, monitoring, reporting, controlling, etc. scan tasks.

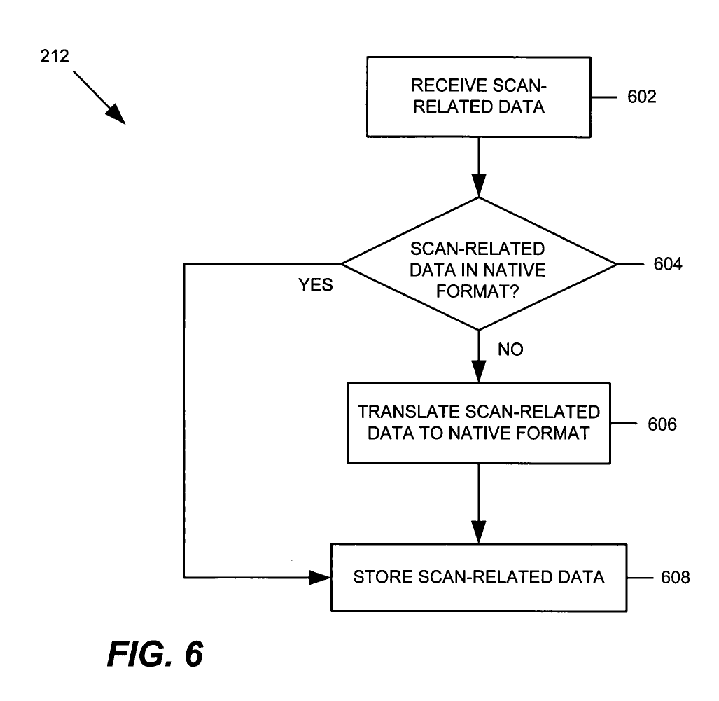

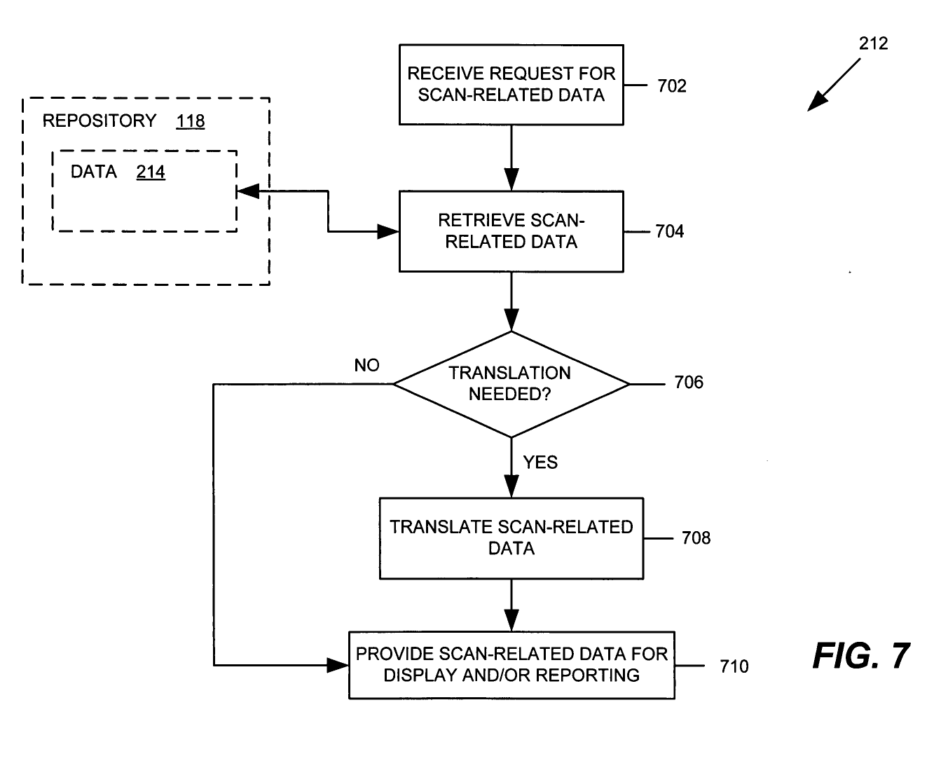

As illustrated in the embodiment of FIG. 2, repository 118 is linked to scanner manager 100 via an application program interface (API) 208. API 208 provides a means for enabling scanner manager 100 to store and/or retrieve data in repository 118. It should be appreciated that scanner manager 100 may also control the storing and/or retrieval of data requested by user(s) 116 (via user interface 202) and scanning tools 104, 106, 108, 110 and 112. In this regard, repository 118 may comprise a database engine 210 for managing the data and memory for storing the data (collectively identified as data 214). As described below in more detail below with respect to FIGS. 6 and 7, scan data translation module 212 provides a mechanism for translating scan data between different data formats. For example, enterprise assessment management system 100 may support nonconforming scanning tool (e.g., legacy scanners, third-party security auditing tools, etc.), in which case scan data translation module 212 may receive data from a nonconforming scanning and translate it to a native data format supported by repository 118. In this manner, all scan-related data may be stored in repository 118 in a single data format, which may provide various benefits to user(s) 116.

Referring to FIG. 2, user interface 202 supports one or more consoles for the various users 116 of the system. User interface 202 enables user(s) 116 to configure various aspects of scanner manager 100. User interface 202 enables user(s) 116 to control, schedule, monitor, etc. scans to be implemented via scanning tools 104, 106, 108, 110 and 112. As described in more detail below, user interface 202 also enables user(s) 116 to access various other modules, functionality, services, etc. supported by scanner manager 100 and repository 118 (e.g., reporting, user management, etc.).

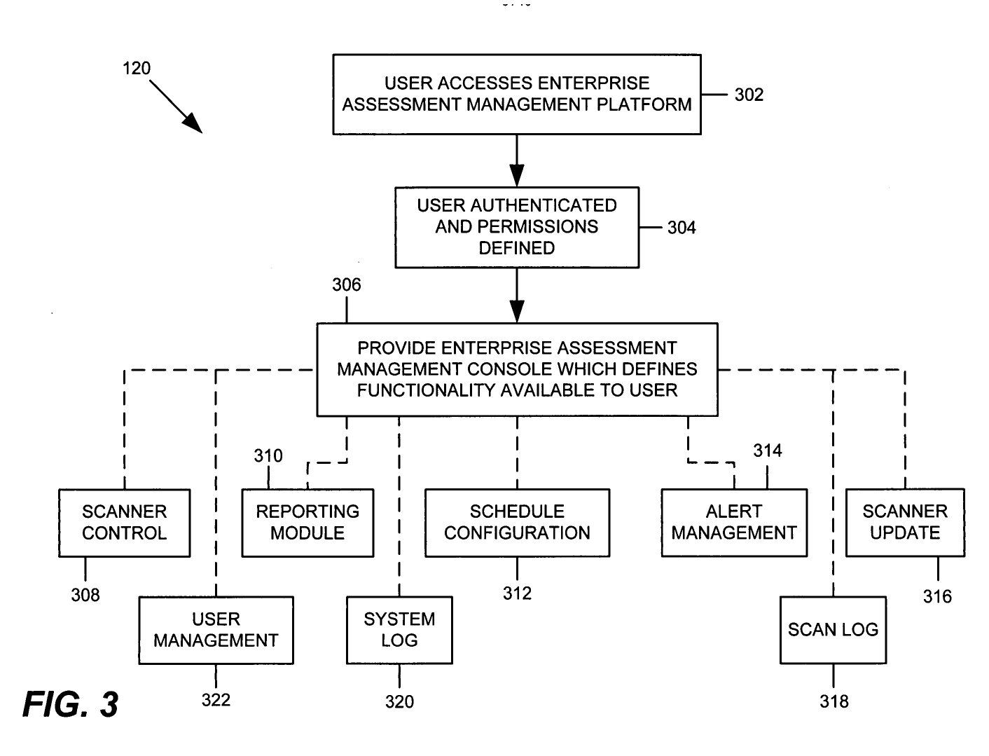

FIG. 3 is a flow chart illustrating several features that may be supported by user interface 202. It should be appreciated, however, that other features may be supported as necessary. Furthermore, it should also be appreciated that the features described with respect to FIG. 3 (or other FIGS.) are not mandatory but rather examples of some useful features that may be supported by scanner manager 100. As illustrated in the embodiment of FIG. 3, at block 302, a user 116 accesses scanner manager 100. At block 304, user 116 may be authenticated via, for example, a log-in process. Of course, the authentication process may be performed in alternative ways, such as by an automatic authentication process. At block 304, after the user is authenticated, user permissions may be defined based on the identity of user 116. For instance, as described below in more detail, scanner manager 100 and/or repository 118 may include various user roles, permissions, etc. which define the functionality to be enabled for the particular user 116. At block 306, an enterprise assessment management console may be provided to the authenticated user 116. Again, any of a number of features may be enabled. As illustrated in FIG. 3, user interface 202 may provide any of the following or other features, modules, functionality, services, etc.: scanner control 308; reporting module 310; schedule configuration 312; alert management 314; scanner update 316; scan log 318; system log 320; and user management 322.

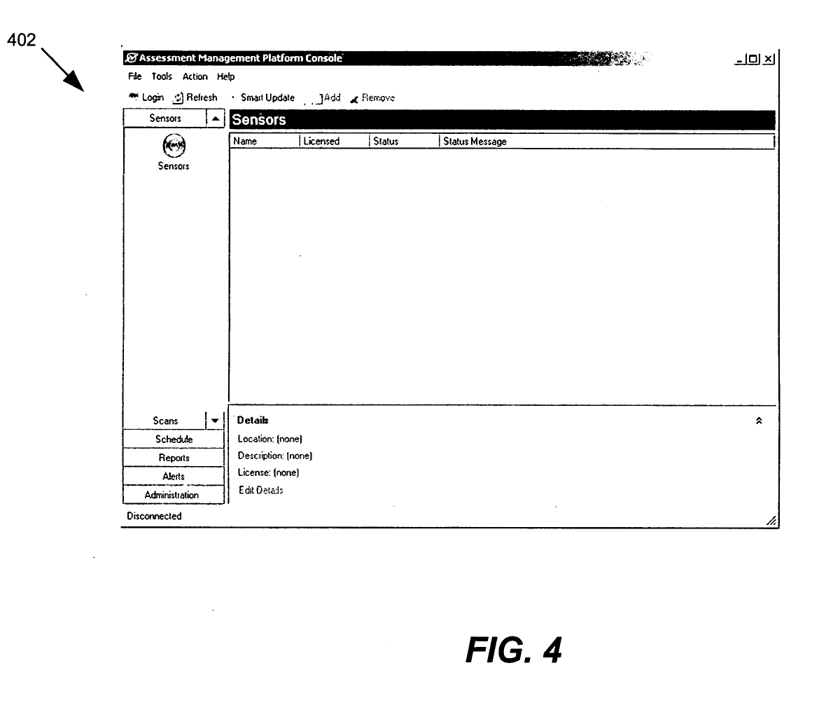

For example, FIG. 4 illustrates a screen shot of a window 402 of a graphical user interface supported by an exemplary embodiment of user interface 202. As illustrated in FIG. 4, window 402 includes a list of the available scanning sensors for the enterprise assessment management system 100, the sensors name, whether or not the sensor is licensed, the sensor's current scanning status, and a message about the status of the sensor at the current time. Window 402 also supports various tabs that initiate other functionality. For example, window 402 includes a “scans” tab, a “schedule” tab, a “reports” tab, an “alerts” tab, and an “administration” tab, to name a few. The scans tab that lists all the scans that have been completed by the sensors. As mentioned above, the scans may have been scheduled or manually started. The scans tab also indicates if the scan was successful or not and if results are available.

The schedules tab allows a user to schedule scans on particular sensors as well as identify blackout times where no scans can be scheduled. All scheduled cans can be configured like a user defined scan. The reports tab allows users to generate reports on scans that have been run. The scans may be run by the user or another user or scheduled—provided the user has the proper role authentication to run reports.

The alerts tab allows users to configure which types of alerts they will get notified about and by what medium. Examples of alerts include, notifying when a vulnerability is found, when a scan completes, or when a scan encounters an error. Examples of alert media include email, pager, or a notification generated to a 3^{rd} party application.

The administration tab allows a user to view logs about the activity of enterprise assessment management system 102. It also allows a user to set up roles which may allow an administrator to restrict privileges of the end user.

As further illustrated in FIG. 4, portion 406 provides a secondary window that displays various properties related to a scanning tool selected via the sensors tab 408. One of ordinary skill in the art will appreciate that portion 406 may display any useful information regarding the selected scanning

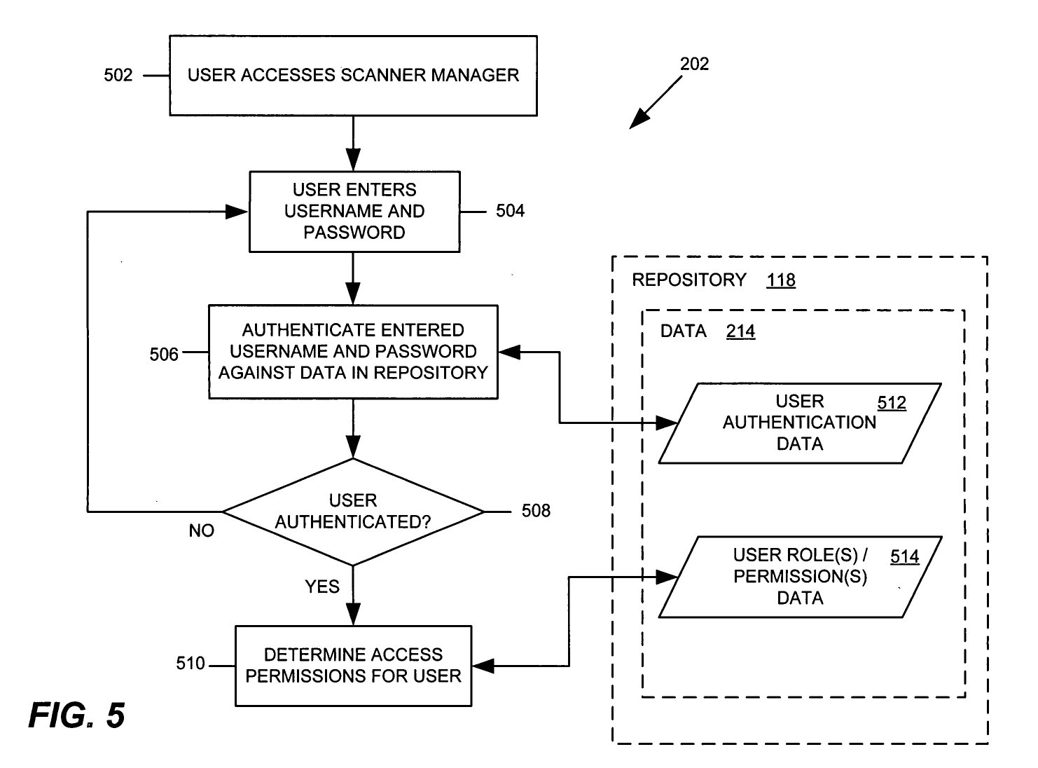

As mentioned above, when a user 116 accesses a console, scanner manager 100 may initiate an authentication process. FIG. 5 illustrates the architecture, operation, and/or functionality of an exemplary user authentication process. At block 502, a user 116 accesses scanner manager 100. At block 504, user 116 enters a username and password. At block 506, scanner manager 100 authenticates the entered username and password against data stored in repository 118 (e.g., user authentication data 512 stored in data 214). As illustrated in FIG. 5, scanner manager 100 may access user authentication data 512 and, at block 508, determine whether the user is authenticate by comparing the entered data against user authentication data 512. If the entered data does not match user authentication data 512, user 116 may be requested to re-enter the username and password at block 504. If the entered data matches user authentication data 512, at block 510, scanner manager 100 may determine access permission(s) for user 116. In this regard, repository 118 may also include data for each user 116, which defines their role and corresponding permission(s) (e.g., user role(s)/permission(s) data 514). Based on the role(s)/permission(s), scanner manager 100 defines the functionality, modules, features, services, etc. to provide to user 116.

One of ordinary skill in the art will appreciate that, in a particular enterprise configuration, responsibility for various sites may be divided among different administrators, groups, etc. Therefore, in order to protect sensitive information, the ability to execute scans on particular systems and to access scan results for particular sites may be controlled by authenticating users and assigning them to appropriate roles that control access levels. In this regard, user authentication data 512 and user role(s)/permission(s) data 514 may be used to create definitions for valid users, roles and role assignments, permissions, etc.

In one embodiment, scanner manager 100 may define roles as named collections of permissions. User(s) 116 may add new roles via user interface 202 and the resulting role information may be stored in repository 118. Permissions may be defined as specific activities that a user may perform, such as “start manual scan” or “generate report.” Individual permissions may be enabled or disabled for every defined role. Some permissions may be further described by a set of IP addresses that constrain when the permission is granted. The IP addresses may be defined as a list of discrete ranges for which the given permission is granted. Roles may also have associated lists of NT user accounts (and optionally NT groups) that are allowed to “act in the role.” Roles may be fully editable from a console where they can be added, deleted, and updated with new users, permissions, IP range data, etc. Edits from the console may be persisted to repository 118.

It should be appreciated that roles define the basic unit of security definition, while permissions define the basic unit of security checking. In one embodiment, scanner manager 100 calls made from a console may flow over .NET remoting channels (described above) which are encrypted and which can impersonate the NT user logged into the console. Thus, the call may be protected by a security check which takes, for example, the form “Is the user running the client application allowed to call method X which is guarded by permission Y?” API calls which initiate scans or reports that are specific to IP ranges add an additional criterion to the check, such as, “Is the user running the client application allowed to call method X which is guarded by permission Y within IP range Z?” Role information may reside in both database engine 210 (accessed via repository APIs) and a scanner manager 100 executable. The executable may contain optimized look-up tables keyed off of specific permissions. The table look-up may make the permissions checks faster because a database lookup is not required for every remote API call.

In some embodiments, the ability to edit and create roles may itself be a granted permission. For instance, remote APIs that deal with role creation or modification may be protected by a specific permission. In this situation, a “Security Admin” role may be created in the database when scanner manager 100 is initiated. Therefore, an administrative user 116 may be automatically set as the sole security administrator and, therefore, the only account capable of creating roles. This user may then create other roles and/or add additional users to the built-in admin role.

As mentioned above, enterprise assessment management system 100 may enforce permissions. Scanner manager 100 may maintain sole responsibility for checking the permission on each API call to avoid any user interface issues that may pose a security threat. It should be appreciated that this methodology may also minimize network traffic and keep a reasonably consistent user experience.

Enterprise assessment management system 102 may define various roles, permissions, etc. For example, a security administrator may be granted with all permissions and with no IP restrictions. A security technician may be granted all permissions except for policy modifications. A manager may be granted all permissions except for “start scans” and policy modifications.

Referring again to the consoles, it should be appreciated that scanner manager 100 may be configured in a number of alternative ways. For example, in one embodiment, the standard mode for the console is a list of scanning tools running on the network. User interface 202 may be configured to display the list of scanning tools so that they may be readily apparent at a glance (e.g., unavailable scanning tools may be unable for user action). Furthermore, user interface 202 may be configured to display progress information (or any other useful data) for active scanning tools that user 116 is authorized to view.

As mentioned above, user interface 202 may enable user(s) 116 to control various scans to be implemented via scanning tools 104, 106, 108, 110 and 112. Scanning tools 104, 106, 108, 110 and 112 may be controlled by first selecting one from the list and then indicating a particular action to perform. For instance, in one embodiment, a user 116 may select a web application scanning tool and then start a particular scan task. User interface 202 may bring up a dialog in which the policy and host to scan are chosen, as well as the particular time(s) to perform the scan along with any black-out contingencies (e.g., black-out time, IP range, server(s), etc.). Scans may be paused or stopped by selecting the scanning tool performing the scan and then hitting a stop scan or pause scan button in user interface 202. User interface 202 may pass these commands to a scanner controller which delegates the tasks to the appropriate scanning tools.

User interface 202 may also enable a user 116 to update a scanning tool. In one embodiment, scanner manager 100 may support two types of scanning tool updates: (1) update binary components; and (2) update vulnerability information for scanning tools. Enterprise assessment management system 102 may be integrated with a SmartUpdate service which is provided by an application service provider. The SmartUpdate service enables enterprise assessment management system 100 to automatically receive information regarding updates to scanning tools 104, 106, 108, 110 and 112, repository 118, or other components in the system. Enterprise assessment management system 102 may be connected to the application service provider and, as updates are made available, they may be passed to scanner manager 100. Scanner manager 100 then passes the update information on to the corresponding components in the system.

In one embodiment, the SmartUpdate service may provide updates to master versions stored in repository 118, and all scanning tools (or other components) then synchronize to the master version. In this manner, only scanner manager 100 needs connectivity to the application service provider.

In an alternative embodiment, the vulnerability database for scanner manager 100 is stored in database engine 210. In order to perform an update, scanner manager 100 retrieves the vulnerability database information from repository 118 and stores it in a temporary disk file. Scanner manager 100 then performs a standard SmartUpdate on the disk file by downloading updates from the application service provider. If no updates were needed to the vulnerability database then the process is complete. If there were updates, then scanner manager 100 copies the updated vulnerability database file back into repository 118. Scanner manager 100 then extracts each policy file from repository 118, resynchronizes the policy file with the updated vulnerability database, and copies the updated policy file back into repository 118.

In addition to the raw vulnerability database data, repository 118 may contain a copy of the reporting and display information for the various checks in a separate set of tables for easy access in reporting. This information may be extracted from an initial vulnerability database file when repository 118 is initialized and kept up to date as the vulnerability database file is updated. As updates are downloaded from the application service provider, they are applied to both the vulnerability database file and to repository tables.

As described below in more detail, scanner manager and/or repository 118 may maintain a log of all actions performed by the various components (e.g., scans started, results uploaded, updates performed, scanning tools added, etc.). User interface 202 may also enable user(s) 116 to view the log.

User interface 202 may also enable user(s) 116 to define alerts. For instance, a particular user 116 may specify the system situations in which to be alerted (e.g., scan completions, scan errors, etc.). In this manner, when scanner manager 100 identifies that the particular event, contingency, etc. has occurred, the user 116 may be notified via, for example, e-mail, pager, etc.

As mentioned above, user interface 202 may be configured to support the addition of pluggable modules that will permit extended functionality. For example, as new scanning tools are developed, scanner manager 100 may be updated to enable these types of tools to be added to the system.

Referring again to FIG. 2, repository 118 provides storage and retrieval of all persistent data for scanner manager 100. For example, data 214 may contain any of the following or other types of data related to the system: scan results; scan policies and settings; task scheduling information; system log and task history; enterprise configuration settings; user authentication and roles (data 512—FIG. 5); and licensing information.

A portion of data 214 comprises the storage of scan results for all scans that are run in the enterprise. As each scan completes, scanner manager 100 passes the results to data 214 via API 208 and database engine 210. Where appropriate (e.g., where the scan data is not in the native data format because the corresponding scanning tool is nonconforming), the scan data may be translated via scan data translation module 212. In this regard, FIG. 6 illustrates the architecture, operation, and/or functionality of an exemplary embodiment of a scan data translation module 212 for providing the translation of scan data into a single, native format. At block 602, scan data translation module 212 receives scan-related data to be logged, stored, etc. The scan-related data may originate from scanner manager 100, one of the scanning tools, or a combination thereof. The scan-related data is passed to repository 118 via API 208. At block 604, scan data translation module 212 determines whether the scan-related data is in so-called “native” format. As described above, some scanning tools may be enterprise compliant (i.e., native to scanner manager 100), while others may be nonconforming (e.g., legacy scanners, third-party security auditing tools, etc.). Scan data translation module 212 may be configured to determine whether the scan-related data being passed to repository 118 is in the appropriate format. If the scan-related data is in native format, at block 608, the scan-related data is stored, logged, etc. in data repository 118. If the scan-related data is not in native format or otherwise in the appropriate data format for storing in repository 118, at block 606, the scan-related data is translated into the appropriate format for repository 118. At block 608, the translated data is stored, logged, etc. in data repository 118.

In the embodiment illustrated in FIG. 2, scan data translation module 212 resides within repository 118. It should be appreciated that, in alternative embodiments, scan data translation module 212 may reside within scanner manager 100. As described below in more detail, in further embodiments, the scan data translation functionality may reside at least partially within the scanning tools (e.g., in a scanner adapter wrapped within the scanning tool). Regardless of the distribution of the translation logic within the system, the important aspect is that the scan-related data is maintained within repository 118 in a single format. In alternative embodiments of enterprise assessment management system 102, the scan-related data may be stored in multiple native formats, native and legacy formats, legacy formats, or any combination thereof.

In embodiments where a single, native format is employed, the schema definition for scan results storage may be based on that of a particular scanning tool. For example, it may be advantageous to employ the schema definition of a particular vendor's scanning tool. In such instances, scanner manager 100, repository 118, and/or scan data translation module 212 may be configured to store and/or retrieve all scan-related information using the schema definition of the particular vendor scanning tool. In these embodiments, it may also be advantageous to store additional scan details (e.g., raw HTTP request, response data, etc.) in order to export a complete scan database that can be viewed and analyzed interactively via user interface 202.

In general, automated scan scheduler 206 schedules scans using recurrence patterns. Automated scan scheduler 206 watches for the configured start time of all scheduled scans. When a scheduled scan is due to run, automated scan scheduler 206 creates a new job for the scan and passes it on to be started. Scanner manager 100 manages the scan job and executes it as soon as scanning resources are available.

Embodiments of scanner manager 100 may also support reporting mechanism(s) for exporting the scan-related data stored in repository 118 to various user(s) 116. It should be appreciated that the scan-related data may be provided to user(s) 116 in a variety of data formats, including native format or any other desired format. In embodiments where the scan-related data is stored in repository 118 in a single, native data format, it may be desirable to export the data in other data formats. In such instances, alternative embodiments of scan data translation module 212 may be used to perform the data translation. In this regard, FIG. 7 illustrates an alternative embodiment and/or implementation of scan data translation module 212. At block 702, scan data translation module 212 receives a request for scan-related data. In some implementations, the request may be initiated by a user 116 via user interface 202. In this regard, scanner manager 100 may support various reporting features, services, etc. via user interface 202. At block 704, scan data translation module 212 retrieves the scan-related data requested by, for example, user 116. The data may be retrieved from repository 118 in a number of ways. For example, the request may be passed to repository 118 via API 208. At block 706, scan data translation module 212 determines whether the scan-related data needs to be translated to a new data format. For example, it may be desirable for a particular user 116 to receive the scan-related data in a format other than the native data format. Scan data translation module 212 may determine that translation is appropriate, in which case, at block 708, the scan-related is translated from native data format to the appropriate data format. Of course, it should be appreciated that the scan-related data may be stored in repository 118 in a variety of formats and scan data translation module 212 may be used to perform the desired translation. If translation of the scan data is not needed, at block 710, the scan-related data is provided for display and/or reporting to, for example, user(s) 116.

Enterprise assessment management system 102 may support various levels of reporting. In one embodiment, enterprise assessment management system 102 supports sophisticated enterprise reporting across all scanning tools in the platform. High-level reporting may be available to convey the overall risk level of the entire enterprise. Enterprise assessment management system 102 may also support reporting capabilities that are specific to particular scanning tools to provide richer and more detailed reports.

As mentioned above, scanner manager 100 may communicate with scanning tools 104, 106, 108, 110 and 112, the consoles, and repository 118 via a remote API. In embodiments, where .NET Remoting interfaces are employed, scanner manager 100 may employ the “ActiveReports” functionality for supporting scheduling and viewing reports immediately. A corresponding viewer functionality may be used to view report data immediately. Scanner manager 100 may be configured to stream report data in a native format back to the consoles. At the console, a user 116 may be able to print and export the report to various supported file formats.

From the user perspective, scanner manager 100 may provide a flexible reporting mechanism that enables user 116 to specify various reporting parameters. For example, user 116 may specify any of the following, or other, types of information when attempting to generate a report: a report template; a scan list specifying the scans, scan types, etc. on which to report; an output location for the report; an export format type (e.g., PDF, HTML, RTF, TIF, TXT, etc.); a e-mail address for notification purposes, etc.

In alternative embodiments, a user 116 may be able to immediately create reports by specifying any of the above information and will be e-mailed when the report is complete. In this manner, user 116 may avoid waiting for the viewer functionality provided via the .NET Remoting interface. This methodology may also provide an integration mechanism for customs that might have existing scheduling programs.

As mentioned above, scanner manager 100 may control scan tasks based on policies that determine which checks are to be performed during the scan process and based on other settings that affect the operation and/or behavior of the scan. Scan policies and/or settings (as well as other scan scheduling information) may be stored in repository 118.

In one implementation, a master version of all policies are stored in repository 118. For a scanning tool to execute a scan, the scanning tool must have access to this information stored in repository 118. To ensure that scans run consistently across all scanning tools, the scanning tool may ensure that its local data is synchronized with the data stored in repository 118. Whenever the scanning tool prepares to start a scan (automatically or manually initiated), it may compare the timestamp and data size of the local data file to the information that scanner manager 100 provides about the master version. If the local copy differs, the sensor use a callback mechanism to download the master version and update the local copy. It may then set the timestamp on the local copy to match the master version. The scanning tool may also check the policy file that is used for the scan in the same way, and use calls back to download the master version if necessary.

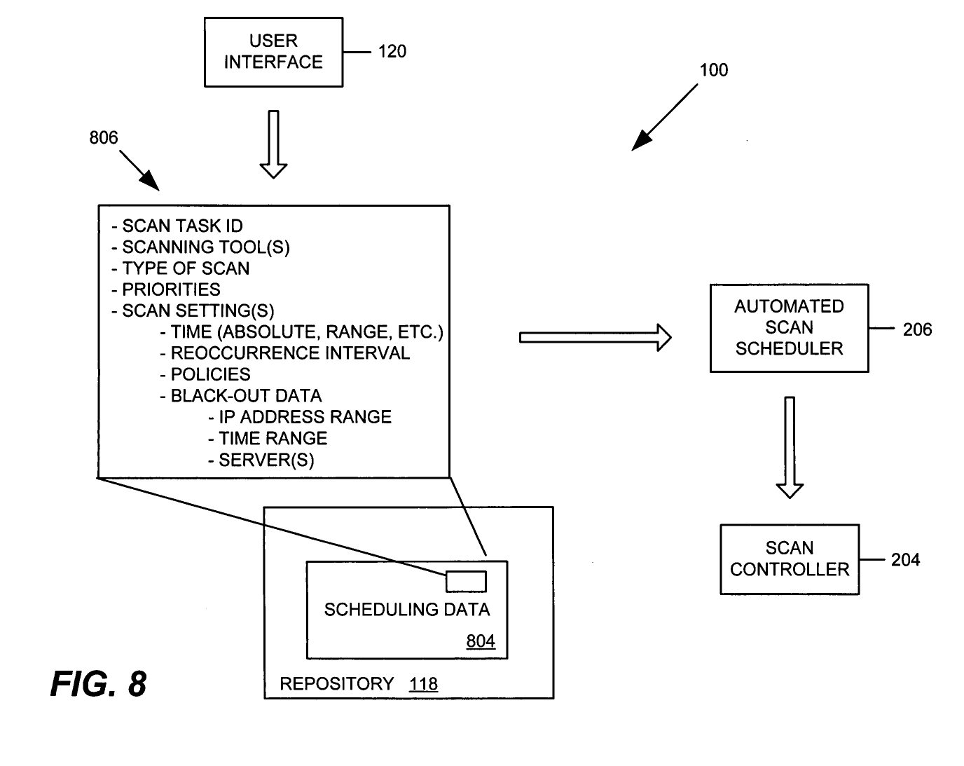

FIG. 8 is a flow chart illustrating the general process flow of an embodiment of scanner manager 100. As illustrated in FIG. 8, scheduling data 804 may be stored in repository 118. Scheduling data 804 generally comprises a plurality of scan tasks 806, each of which define the parameters for a particular scanning operation to be performed via scanning tools 104, 106, 108, 110 and 112. It should be appreciated that a number of scheduling parameters may be defined for each scan task 806. As illustrated in the embodiment of FIG. 8, scan tasks 806 may include any of the following, or other, parameters related to a scanning process for one or more scanning tools: scan task identifier; scanning tools for implementing the scan; type of scan; scan priorities; and scan settings. The scan settings may specify a particular time to perform the scan (e.g., an absolute time, time range, etc.). The scan settings may also specify reoccurrence intervals for performing the particular scan (e.g., per month, per week, etc.), as well as additional scan policies.

Scan tasks 806 may also define black-out contingenc(ies) that define one or more situations in which the corresponding scan task should not be scheduled. For example, there are many cases in which it may be desirable to prevent the scanning of certain targets to occur during certain time periods. Therefore, in certain embodiments where desirable, a scan task 806 may be configured (e.g., via user interface 202—FIG. 8) to restrict the scanning of certain targets. A black-out period may be specified using a recurrence pattern similar to a scheduled scan but with both a start time and a duration. The black-out contingency may define a block of time during which scanning should not occur. In alternative embodiments, the black-out contingency may specify a particular range, list, etc. of IP addresses not to scan. The black-out contingency may also be specified in terms of an exclusive range, list, etc. of IP addresses that should be scanned.

In operation of an exemplary embodiment, if a scan is initiated (e.g., either manually or via a scheduled scan) during a black-out contingency, then the scan is not started immediately but is instead placed in a pending job queue to be started when the black-out contingency ends. If a scan is running when a black-out contingency exists, then that scan may be automatically suspended and placed in the pending queue to be resumed when the black-out contingency no longer exists. If the black-out contingency includes an IP range, for example, the scan may be suspended based only on the IP address of the host for the initial target configured in the scan. If a scan happens to span multiple hosts, scanner manager 100 may be configured so that the scan is not suspended automatically where one of the additional hosts is blacked-out. For instance, scanner manager 100 may be configured with a setting that allows a user 116 to disable automatic suspending for black-outs, allowing a running job to run to completion even if a black-out contingency occurs during the scan.

Referring again to FIG. 8, scan task(s) 806 may be configured by user(s) 116 via user interface 202 and stored in repository 118 (as scheduling data 804). As mentioned above, scanner manager 100 may include an automated scan scheduler 206 that automatically controls scheduled scan tasks 806. As illustrated in FIG. 8, automated scan scheduler 206 may interface with repository 118 (e.g., via API 208) to access scheduling data 804. Automated scan scheduler 206 may implement scheduled scans via scan controller 204. Of course, automated scan scheduler 206 may include logic (separate from scan controller 204) for initiating scan task(s) 806.

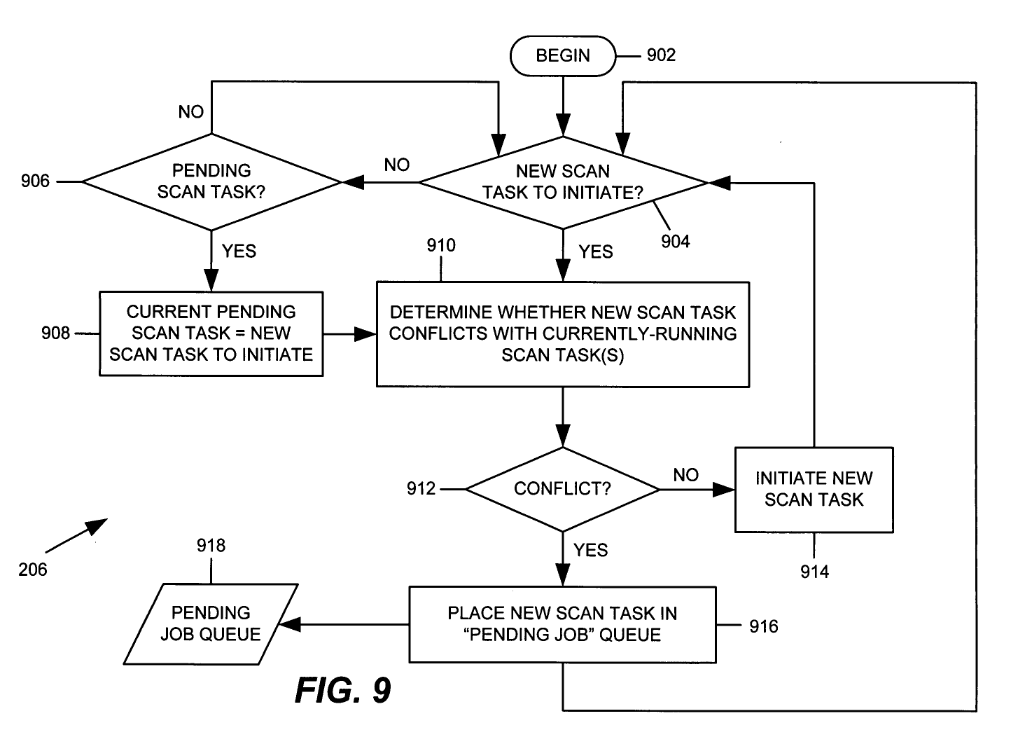

FIG. 9 illustrates the architecture, operation, and/or functionality of an embodiment of automated scan scheduler 206. At block 902, automated scan scheduler 206 is initiated. At block 904, automated scan scheduler 206 determines whether there is a new scan task 806 to initiate. As mentioned above, automated scan scheduler 206 may determine new scan task(s) 806 by accessing scheduling data 806 in repository 118. If a new scan task 806 is scheduled, at blocks 910 and 912, automated scan scheduler 106 may determine whether the new scan task 806 conflicts with any currently-running scan task(s) 806. Automated scan scheduler 206 may manage a variety of types of conflicts between scan task(s) 806.

When a conflict occurs between a scan that is already running on a scanning tool and another scan task that is scheduled to run, automated scan scheduler 206 determines which scan has priority. In one embodiment, automated scan scheduler 206 may manage the conflict by sending the new scan task 806 to the scanning tool for consideration. In this manner, the scanning tool may determine whether a real conflict exists. If the scanning tool cannot handle the new scan task 806, the scanning tool may return a “busy” status to automated scan scheduler 206. In alternative embodiments, automated scan scheduler 206 may be configured with logic for automatically identifying and/or resolving conflicts. If a conflict exists and cannot be resolved, at block 916, the new scan task 806 may be placed in a pending job queue 918. If no conflict exists (or the scanning tools or automated scan scheduler 206 resolves the conflict), at block 914, the new scan task 806 is initiated.

Referring again to block 904, if there are no new scan task(s) 806 to initiate, at block 906, automated scan scheduler 206 may determine whether there are any pending scan task(s) 806 in pending job queue 918. If there are no pending scan task(s) 806, block 904 may be repeated. If there are pending scan task(s) 806, at block 908, automated scan scheduler 908 sets the current pending scan task as the new scan task 806 to initiate and flow moves to block 910. It should be appreciated, however, that blocks 906, 908 and 918 represent one implementation of a process by which conflicts may be resolved. In this embodiment, pending job queue 918 provides a buffer for holding scan task(s) 806 until the conflict is either resolved or the situation creating the conflict no longer exists. One of ordinary skill in the art will appreciate that automated scan scheduler 206 may employ various alternative means for identifying and/or resolving conflicts between scheduled scan task(s) 806.

For example, pending job queue 918 and automated scan scheduler 206 may be configured with a priority scheme. If the priority of the new scan task is lower than the scan that is currently running on the scanning tool, then the new scan task 806 will wait in pending job queue 918 until the current scan finishes or until another scanning resource is available. However, if the new scan task 806 has a higher priority than the current scan, the scanning tool may automatically initiate a suspend of the current scan, so that it will be free to run the higher priority scan. Once the suspend is complete, automated scan scheduler 206 may place the suspended scan task into pending job queue 918 to be resumed later.

When a scanning tool has completed or suspended the current scan, it may indicate that the scanning tool is now available for another scan task 806. Automated scan scheduler 206 may then access pending job queue 918 to determine the highest priority scan task 806 that is eligible to run on the scanning tool. It should be appreciated that a scan task 806 may be eligible to run on the scanning tool in any of the following, or other, situations: if it was configured to run only on that scanning tool; if it was configured to run on any scanning tool and has not yet been started; and if it was previously suspended on that scanning tool. In further embodiments, automated scan scheduler 206 may be configured to resume a suspended scan task 806 on a different a different scanning tool than where it was started.

Furthermore, it should be appreciated that automated scan scheduler 206 may be configured to resolve certain conflicts by assigning scan task(s) to different scanning tools. In one embodiment, automated scan scheduler 206 may determine which type of scanning tools are currently connected to network 114 (FIG. 1). If there is a connected scanning tool that is currently idle, automated scan scheduler 206 may use that scanning tool. If all scanning tools are busy, automated scan scheduler 206 may choose the scanning tool running the lowest priority scan task 806.

As mentioned above, repository 118 may store any persistent data for the system. Thus, as illustrated in the embodiment of FIG. 3, scanner manager 100 may employ a system log 320 and a scan log 318. System log 320 and scan log 318 may store chronological logging information about the execution of scan tasks 806. It should be appreciate that any useful information may be stored, logged, etc. For example, any of the following, or other, types of information may be used: scans started; scans completed; and scan failures. It should be further appreciated that logs 318 and 320 may be useful for user(s) 116 checking whether or not scheduled scan tasks 806 were properly completed.

Repository 118 may also include general configuration information that is used to control the overall operation of the system. This information might include descriptions of available scanning tools, addressing information for locating services on network 115, etc. It should be appreciated that some settings may be stored outside of repository 118 as desired. For instance, in certain implementations, information such as database connection strings that specify how to establish access to repository 118 may be stored in an alternate storage mechanism.

Another embodiment of a scanner manager 100 will be briefly described to illustrate various alternative implementations. As mentioned above, scanner manager 100 is the central controlling component of the enterprise architecture. Scanner manager 100 may be configured to handle all interaction with scanning tools, as well as monitoring the activity of the components in the architecture. In one specific implementation, sensor manager 100 is implemented as a multi-threaded server that can handle simultaneous connections with consoles (via user interface 202) and scanning tools 104, 106, 108, 110 and 112. Scanner manager 100 may include logic, functionality, etc. to support the following features: scheduled job monitoring/initiation; scan control; scan monitoring; asynchronous command dispatching (e.g., command line, console, scanning tool, etc.); monitoring and logging of system components; alerting; automatic updating of system components, including scanning tools; and heart-beat pinging of connected event sources.

Scanner manager 100 may be (although need not be) configured so that it is always. Therefore, as consoles and scanning tools become active, they may connect to sensor manager 100. Scanner manager 100 maintains a list of active scanning tools and corresponding properties (e.g., location, type, current state, last updated date and time, etc.). As mentioned above for other embodiments of scanner manager 100, user(s) 116 may view a list of active sensors via a console.

Scanning tools 104, 106, 108, 110 and 112 and consoles may be configured by an administrator, installer, or other user 116 with endpoint information (e.g., network address of scanner manager 100, etc.) for initiating connections with scanner manager 100. In this manner, new components may be added to the framework without requiring manual installation of software at multiple hosts.

Scanner manager 100 may initiate connections with repository 118. As mentioned above, repository 118 may provide an API 208 to scanner manager 100. Scanner manager may request scheduling data from repository 118. Scanner manager may also build an in-memory data structure for representing all scheduled scan tasks 806. Scanner manager 100 may maintain a background thread that periodically checks the in-memory schedule data and initiates scheduled scan tasks 806 on connected scanning tools. This thread may sleep until the next check-interval has expired in order to reduce processing resources.

Referring again to FIG. 1, scanning tools 104, 106, 108, 110 and 112 may connect to scanner manager 100 using a remote application program interface (API). In one implementation, scanning tools 104, 106, 108, 110 and 112 communicate with scanner manager 100 via standard NET remote APIs and will make method calls through a proxy object reference.

Once scanning tools connect to scanner manager 100, they pass an object reference to themselves to scanner manager 100. Scanner manager 100 may deserialize these references into proxy objects that may be used to make calls on the remote scanning tools. Scanner manager 100 may maintain a list of these connected scanning object references that will be periodically polled for status information. The state polling interval may be user-configurable.

Scanner manager 100 may be configured for dispatching commands to other components in the architecture. Commands to the scanning tools, either scheduled or immediate, may be sent to the scanning tools from scanner manager 100. Upon completion of a scan, scanner manager 100 may direct the scanning tool to upload the scan results to repository 118.

Scanner manager 100 may also monitor the interactions between the components of the enterprise architecture and log these activities in repository 118. The level of logging may be user configurable.

Scanner manager 100 may periodically request alert information from repository 118 and store them in memory. As events occur within the enterprise architecture, scanner manager 100 may check its lists of alert triggers and fire off an alert (e.g., via e-mail, network messages, etc.) should any of these events occur.

Scanner manager 100 may be configured to automatically update components in the enterprise architecture. Scanner manager 100 may receive various updates via a remote connection. After receiving the updates, scanner manager 100 may pass on the updates to the corresponding components, in which cases the components may update themselves.

Scanner manager object and interfaces may be accessible via a command line console program. Alternative wrappers may be employed to enable administrators to build scripts that make use of scanner manager 100.

As mentioned above, some scanning tools may be enterprise compliant (i.e., native to scanner manager 100), while others may be nonconforming (e.g., legacy scanners, third-party security auditing tools, etc.). Scanner manager 100 may be configured without regard to whether the scanning tools are enterprise compliant or nonconforming. In other words, the enterprise assessment architecture may be configured so that scanner manager 100 does not distinguish between enterprise-compliant scanning tools and other scanning tools.

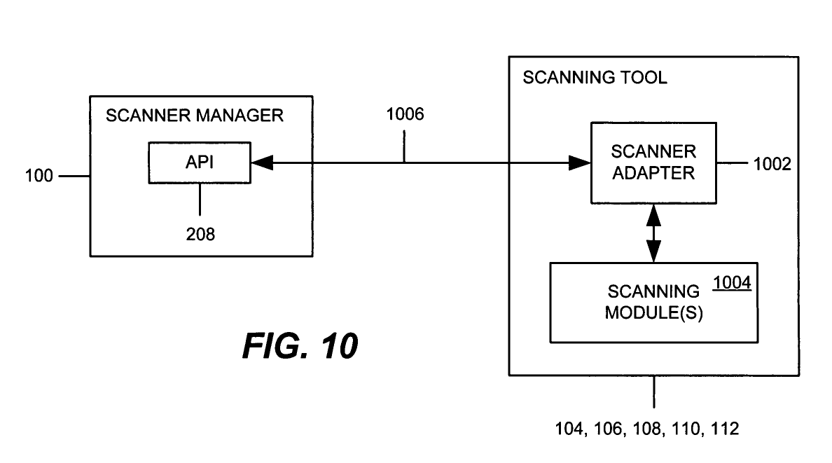

FIG. 10 illustrates an exemplary embodiment of the communication between scanning tools 104, 106, 108, 110 and 112 and scanner manager 100. As described above, a scanning tool may be wrapped with an adapter layer (e.g., scanner adapter 1004). Scanner adapter 1004 provides a communication layer between API 208 of scanner manager 100 and the scanning logic, functionality, etc. of scanning tools 104, 106, 108, 110 and 112. In this manner, scanner adapter 1004 provides the interface between scanner manager 100 and the scanning tools. It should be appreciated that scanner adapter 1004 provides a flexible mechanism for enabling scanner manager 100 to support additional third-party scanning tools, legacy scanning tools, etc.

It should be further appreciated that scanner adapter 1004 may be configured in a number of ways. For example, in one embodiment, scanner adapter 1004 is implemented as a Windows-based service that connects to scanner manager 100 and enables scanner manager 100 to listen for commands. In these embodiments, the Windows-based service may control scanning module(s) 1006 by instantiating an object exposed by module(s) 1006.

Scanner adapter 1004 may be installed, integrated, or otherwise combined with the scanning tools. Thus, it should be appreciated that third-party applications may be developed and manufactured with scanner adapter 1004. In further embodiments, an administrator may configure the third-party application with scanner adapter 1004. Regardless of the implementation, scanner adapter 1004 may be configured with appropriate information for contacting scanner manager 100 (e.g., network address, port, etc.). In this manner, scanner adapter 1004 may initiate a connection to scanner manager 100.

In operation, when the scanning tool is started, scanner adapter 1004 will connect to scanner manager 100 and announce that it is active. Scanner manager 100 may send appropriate commands to scanner adapter 1004, which it may either perform itself or delegate to scanning module(s) 1006.

In one exemplary embodiment, scanner adapter 1004 is configured to receive any of the following, or other, types of commands: start, pause, stop, etc. the scanning tool; retrieve the status of the scanning tool; upload the results of a scan; and update the components and/or vulnerability information for a scanning tool. It should be appreciated that scanner adapter 1004 may be configured to support additional features, functions, etc.

Sensor adapter 1004 may control scanning module(s) 1006 by calling associated methods (e.g., StartScan, PauseScan, ContinueScan, etc.) that are exposed by a particular object. When scanner manager 100 initiates a scan task 806, the appropriate information for the scan may also be passed to scanner adapter 1004. Scanner manager 100 may also periodically poll scanner adapter 1004 to retrieve information related to the scan (e.g., scan status, completion, errors, etc.). Scanner adapter 1004 may subscribe to the various status events scanning modules 1006, such as: job started; job paused; crawling; scanning; job complete, etc. It should be appreciated that, depending on the particular scanning tool, the scanning status may also contain details regarding the current recursion level, the audit engine currently executing, the audit engine's percentage complete, etc.

Upon detecting that a scan has completed, scanner manager 100 may signal to scanner adapter 1002 to upload the scan results from scanning tool(s) 1006 to repository 118. Scanner manager 100 may also use scanner adapter 1002 to update scanning module(s) 1004. For instance, scanner manager 100 may indicate to scanner adapter 1002 that a sensor update needs to be performed. Scanner manager 100 may pass the update files to scanner adapter 1002, which will then copy them to, for example, an update directory associated with the scanning tool. Scanner adapter 1002 may then call an automated update method to complete the process.

One of ordinary skill in the art will appreciate that various aspects of enterprise assessment management system 102 (including the various components) may be implemented in software, hardware, firmware, or a combination thereof. It should be further appreciated that the process descriptions or blocks related to the FIGS. represent modules, segments, or portions of code which include one or more executable instructions for implementing specific logical functions or steps in the process. It should be further appreciated that any logical functions may be executed out of order from that shown or discussed, including substantially concurrently or in reverse order, depending on the functionality involved, as would be understood by those reasonably skilled in the art.

Furthermore, enterprise assessment management system 102 may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

What is claimed is:

1. An enterprise assessment management system comprising:
a plurality of scanning tools including at least one web application scanning tool; and
an enterprise assessment management server comprising a scanner manager that controls the plurality of scanning tools.

2. The enterprise assessment management system of claim 1, further comprising a repository that provides storage and retrieval services for scanning data corresponding to the plurality of scanning tools.

3. The enterprise assessment management system of claim 2, further comprising an application interface for importing the scanning data corresponding to the plurality of scanning tools.

4. The enterprise assessment management system of claim 3, wherein the application interface comprises a translation component configured to receive the scanning data from the plurality of scanning tools in a native data format.

5. The enterprise assessment management system of claim 3, further comprising a reporting module that merges the scanning data from the plurality of scanning tools into a central reporting mechanism.

6. The enterprise assessment management system of claim 1, further comprising a user interface that controls communication with at least one user console.

7. The enterprise assessment management system of claim 6, wherein the enterprise assessment management server comprises a user authentication module for controlling user access via the at least one user console.

8. The enterprise assessment management system of claim 7, wherein the enterprise assessment management server enforces user roles that define access permissions.

9. The enterprise assessment management system of claim 1, further comprising an automated scan scheduler that controls scan tasks to be implemented on the plurality of scanning tools.

10. The enterprise assessment management system of claim 9, wherein the automated scheduler manages conflicts between scan tasks.

11. The enterprise assessment management system of claim 10, wherein the automated scheduler supports a black-out contingency which defines a situation in which a corresponding scan task should not be scheduled.

12. The enterprise assessment management system of claim 11, wherein the black-out contingency is based on one of a time range, an IP address range, and an identified server.

13. The enterprise assessment management system of claim 1, wherein the plurality of scanning tools and the enterprise assessment management server communicate via a remote application program interface.

14. The enterprise assessment management system of claim 1, wherein the enterprise assessment management server comprises an application program interface that supports communications with at least one of the plurality of scanning tools via a scanner adapter which is integrated with the at least one of the plurality of scanning tools.

15. The enterprise assessment management system of claim 14, wherein the scanner adapter is configured with a network address corresponding to the enterprise assessment management server.

16. The enterprise assessment management system of claim 1, wherein at least one of the plurality of scanning tools comprises one of an application scanner, a system scanner, the web application scanner, a database scanner, and a network scanner.

17. An enterprise assessment management platform comprising:
a scanner manager configured to control a plurality of scanning tools, at least one of the plurality of scanning tools comprising a web application scanning tool;
a repository for storing scanning data corresponding to the plurality of scanning tools; and
a user interface that controls communication with at least one user console.

18. The enterprise assessment management platform of claim 17, further comprising an application program interface for importing the scanning data corresponding to the plurality of scanning tools, the application program interface comprising a translation component configured to receive the scanning data in a native data format.

19. The enterprise assessment management platform of claim 18, further comprising a reporting mechanism that merges the scanning data from the plurality of scanning tools.

20. The enterprise assessment management platform of claim 18, wherein the application program interface supports communications with at least one of the plurality of scanning tools via a scanner adapter which is integrated with the at least one of the plurality of scanning tools.

21. The enterprise assessment management platform of claim 20, wherein the scanner adapter is configured with a network address corresponding to the scanner manager.

22. The enterprise assessment management platform of claim 17, wherein the scanner manager comprises a scan scheduler that controls scan tasks to be implemented on the plurality of scanning tools.

23. A method for assessing the vulnerability of an enterprise network, the method comprising:
configuring a plurality of scanning tools for communication with a scanner manager, at least one of the plurality of scanning tools comprising a web application scanning tool;
connecting at least one of the plurality of scanning tools to the scanner manager;
requesting scheduling data from a repository; and
automatically scheduling a scan task to be implemented on the corresponding scanning tool based on the scheduling data retrieved from the repository.

24. The method of claim 23, wherein the configuring a plurality of scanning tools comprises integrating a scanner adapter with at least one of the plurality of scanning tools.

25. The method of claim 23, wherein the connecting at least one of the plurality of scanning tools to the scanner manager involves a remote application program interface.

26. The method of claim 23, further comprising receiving scan data from one of the plurality of scanning tools.

27. The method of claim 26, further comprising translating the scan data from a native format.

28. The method of claim 26, further comprising merging the scan data from the plurality of scanning tools into a central reporting mechanism.

29. The method of claim 23, further comprising establishing communication with a user console.

30. The method of claim 29, further comprising authenticating a user and enforcing user permissions associated with the user.

31. The method of claim 23, wherein the automatically scheduling a scan task involves resolving a scheduling conflict.
